(19) United States
(12) Patent Application Publication
(10) Pub. No.: US 2017/0225516 A1
(43) Pub. Date: Aug. 10, 2017

(54) TIRE TREADS HAVING A ZERO THICKNESS SIPE

(71) Applicants: Sadi KOSE, Greer, SC (US); Robert Cecil LAWSON, Pelzer, SC (US)

(72) Inventors: Sadi KOSE, Greer, SC (US); Robert Cecil LAWSON, Pelzer, SC (US)

(73) Assignees: COMPAGNIE GENERALE DES ETABLISSEMENTS MICHELIN, Clermont-Ferrand (FR); MICHELIN RECHERCHE ET TECHNIQUE S.A., Granges-Paccot (CH)

(21) Appl. No.: 15/515,364

(22) PCT Filed: Sep. 30, 2015
(86) PCT No.: PCT/US2015/053274

§ 371 Date: Mar. 29, 2017

Related U.S. Application Data
(60) Provisional application No. 62/057,708, filed on Sep. 30, 2014.

(51) Int. Cl. B60C 11/12; B29D 30/68; B29D 30/06

(52) U.S. Cl. CPC B60C 11/1204; B29D 30/0606; B29D 30/68; B29D 2030/0613; B60C 2011/1213; B60C 2011/1277

(57) ABSTRACT

A method of forming a tire includes a mold having a molding cavity defined at least in part by an outermost molding surface and a pair of opposing shoulder-forming portions. The mold includes a sipe-forming element spaced apart inwardly from the pair of opposing shoulder-forming portions with a knife edge oriented towards a first shoulder-forming portion and a knife edge translation member arranged outside the mold cavity and configured to translate in a direction towards the first shoulder-forming portion and from which a sipe-forming portion extends. The method further includes arranging an uncured tire tread within the mold, molding the uncured tire tread, and demolding the tire tread such that the sipe-forming element forms a sipe by the knife edge lacerating a thickness of the cured molded tread as the sipe-forming element is pulled in a direction toward the shoulder-forming portion.

This application claims priority to, and the benefit of, U.S. Provisional Patent Application No. 62/057,708 filed on Sep. 30, 2014 with the United States Patent Office, which is hereby incorporated by reference.

### BACKGROUND OF THE INVENTION

Field of the Invention

This invention relates generally to methods and apparatus for forming essentially zero-thickness sipes (also referred to herein more simply as “zero-thickness sipes”), and treads and tires having zero-thickness sipes.

Description of the Related Art

Tire treads are known to include a pattern of voids and such arranged along a ground-engaging side of the tread to provide sufficient traction and handling during particular conditions. For example, grooves provide void into which water, mud, or other environmental materials may be diverted to better allow the tread surface to engage a ground surface. It is also known to use sipes to create edges along the ground-engaging surface of the tread, which improve traction when operating in wet, snowy, or icy conditions. Commonly, sipes are formed by molding a narrow slot or groove into the tread. With the presence of void within a sipe, the stiffness of the tread may decrease, which may also reduce the tire traction and handling. Therefore, there is a desire to form zero-thickness sipes by reducing or generally eliminating the concurrent formation of void within the sipe. Also, it is desirous to form sipes without generating much or any additional void along the ground engaging side, as the addition of void reduces the amount of ground-engaging tread surface (also referred to as “contact surface”) available for contacting the ground during tire operation. When reducing the amount of contact surface available, wear performance may also decrease.

### SUMMARY OF THE INVENTION

Embodiments of the invention include methods for forming a tire. Particular embodiments of such methods include a step of providing a mold configured to mold a tire tread. The mold has a molding cavity defined at least in part by an outermost molding surface configured to form a ground-engaging surface of the tire tread and a pair of opposing shoulder-forming portions configured to form a pair of opposing shoulders of the tire tread. The outermost molding surface is arranged between the pair of opposing shoulder-forming portions. The mold further includes a sipe-forming element spaced apart inwardly from each of the pair of opposing shoulder-forming portions. The sipe-forming element includes a knife edge oriented towards a first shoulder-forming portion of the pair of opposing shoulder-forming portions. The knife edge has a length extending in a direction transverse to a direction extending between the pair of opposing shoulder-forming portions. The sipe-forming element further includes a knife edge translation member arranged outside the mold cavity and configured to translate in a direction towards the first shoulder-forming portion and from which a sipe-forming portion extends, the sipe-forming portion including the knife edge. Particular embodiments of such methods further include a step of arranging an uncured tire tread within the mold, the uncured tire tread having a thickness extending depthwise from the outermost molding surface such that a portion of the tire tread is arranged between the knife edge and the first shoulder-forming portion. Particular embodiments of such methods further include a step of molding the tire tread arranged within the mold to form a cured molded tread having a thickness extending from a ground-engaging side of the cured molded tread and a width extending between opposing lateral sides of the tire tread, the tire tread further including a pair of shoulders each arranged along one of the lateral sides of the tire tread, each of the shoulders extending in a direction of the tread thickness. Embodiments of such method further include a step of demolding the tire tread from the mold such that the sipe-forming element forms a sipe by the knife edge lacerating a thickness of the cured molded tread as the sipe-forming element is pulled in a direction toward the first shoulder-forming portion, the sipe comprising a laceration having a thickness substantially equal to zero and having length extending in a direction of the tread width from the first shoulder formed by the first shoulder-forming portion.

Further embodiments of the invention comprise a tire molded by the above methods.

Yet further embodiments of the invention provide a molded tire. The molded tire comprising a pair of sidewalls extending radially outward to a central portion of the tire, the pair of sidewalls being spaced apart in an axial direction of the tire. The molded tire further includes a tire tread having a width extending in a lateral direction between a pair of opposing lateral sides of the tire tread and a pair of shoulders spaced apart and on opposing lateral sides of the tread width, the tire tread being arranged along a radially outer side of the central portion between the pair of sidewalls. The tire tread includes a thickness extending from a ground-engaging side to a bottom side within the central portion of the tire and a sipe comprising a laceration formed during a demolding operation. The sipe includes a length extending in a direction of the tread width from a first shoulder of the pair of shoulders of the tire tread, a depth extending in a direction of the tread thickness.

The foregoing and other objects, features, and advantages of the invention will be apparent from the following more detailed descriptions of particular embodiments of the invention, as illustrated in the accompanying drawings wherein like reference numbers represent like parts of the invention.

### DETAILED DESCRIPTION OF THE DRAWINGS

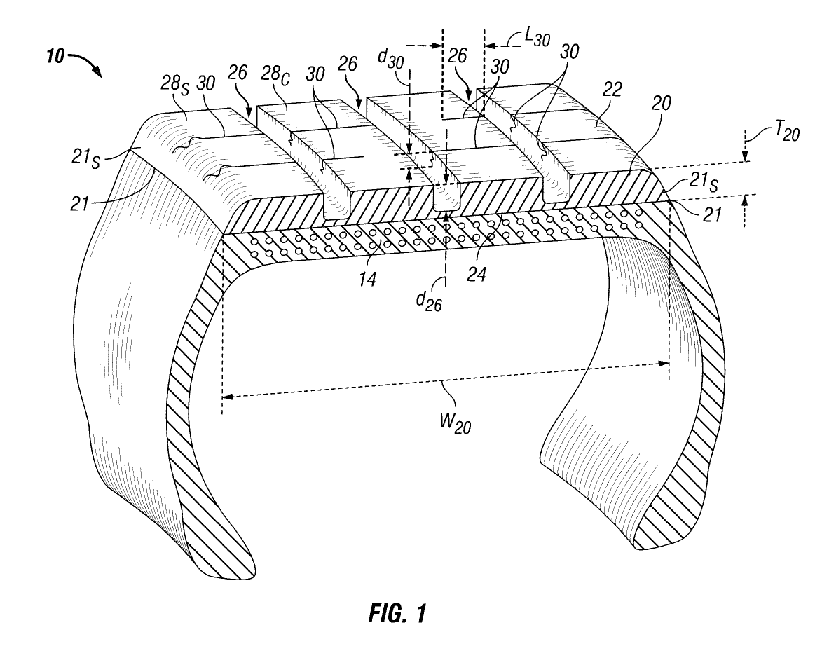

FIG. 1 is a perspective, partial cutaway view of a tire, in accordance with an embodiment.

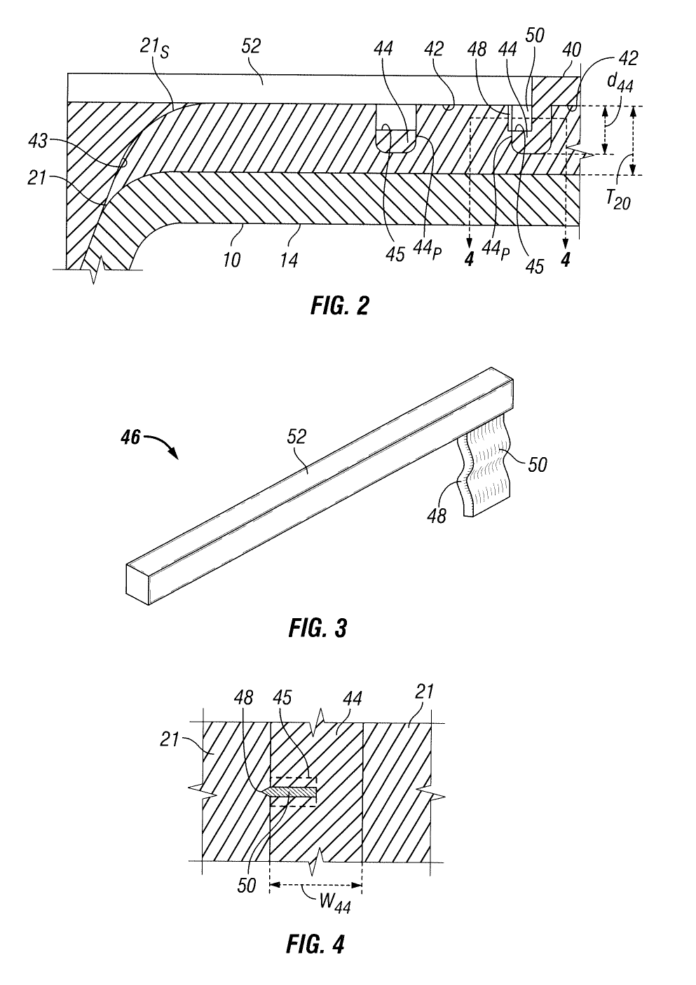

FIG. 2 is a side, partial cutaway, view of a tire tread arranged in a mold including a sipe-forming element for forming a zero-thickness sipe, in accordance with an embodiment.

FIG. 3 is a perspective view of the sipe-forming element shown in FIG. 2.

FIG. 4 is a top sectional view taken along line 4-4 in FIG. 2 showing the sipe-forming element arranged within a cavity of the groove-forming element.

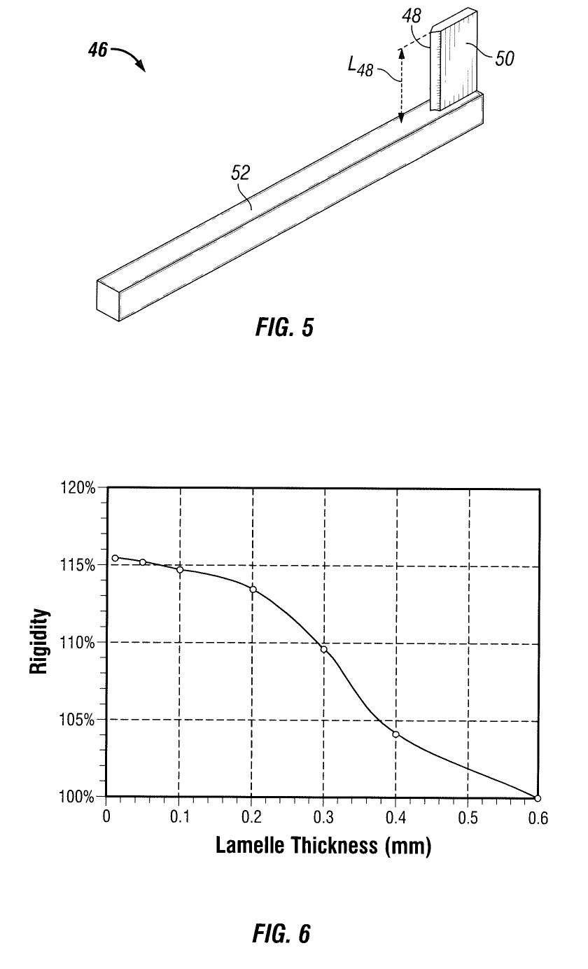

FIG. 5 is an inverted perspective view of a sipe-forming element having a sipe-forming portion substantially shaped and sized equivalent to the cross-sectional shape and size of the groove-forming element, in accordance with an alternative embodiment of the invention.

FIG. 6 is a chart showing the results of a simulation performed, where tire treads having zero-thickness zig-zag sipes show an increase in transverse rigidity relative to tire treads having standard sipes.

### DETAILED DESCRIPTION OF PARTICULAR EMBODIMENTS

Particular embodiments of the invention provide a tire including zero-thickness sipes (also referred to as “lamelles”), tire molds and methods for forming such sipes, as well as treads and tires having such treads having substantially zero-thickness sipes (also referred to herein more simply as “zero-thickness sipes”).

Disclosed in this application is a method of forming a tire tread or tire having a tire tread, each of which include one or more sipes each comprising a laceration or slice extending through a thickness of the tire tread.

In particular embodiments, such methods include a step of providing a mold having a molding cavity configured to mold a tire tread. The mold may comprise a tire mold, which is configured to receive a tire having a tire tread for molding, or only a tire tread, such as when forming a tread for later application to a tire carcass in retreading operations, for example. Any such mold generally has an annular molding cavity, and may comprise any type of mold, such as a clamshell mold or a segmented mold, for example. In any event, any such mold includes a molding cavity defined at least in part by an outermost molding surface configured to form a ground-engaging side or surface of the tire tread. The outermost molding surface can also be referred to as the ground-engaging molding surface or portion of the mold or molding cavity. The outermost molding surface is arranged along an outer cavity side, which is generally annular or circumferential in shape. Therefore, when relating any feature of the mold or tire tread to the outermost molding surface, the same relation can be made or drawn relative to the outer cavity side by substituting the outer cavity side for the outermost molding surface. Any such mold also includes a pair of opposing shoulder-molding portions configured to form a pair of opposing shoulders of the tire tread, the outermost molding surface being arranged between the pair of opposing shoulder-molding portions. It can also be said that the pair of opposing shoulders are spaced apart and arranged on opposing lateral sides of the tread width.

Any such mold further includes a sipe-forming element spaced apart inwardly from each of the pair of opposing shoulder-molding portions, such that the sipe-forming element is arranged between the pair of opposing shoulder-molding portions in a direction of a molding cavity width, where the width of the molding cavity is configured to form a width of the tire tread. Because sipe-forming element is configured to be removed from the tire tread to cut or lacerate a sipe into a thickness of the tread, by being spaced apart, an area is formed between one of the pair of opposing shoulder-molding portions and the sipe-forming element for receiving tread material in which a sipe will be cut during a demolding operation. Accordingly, the sipe-forming element, and more specifically, a sipe-forming portion of the sipe-forming element, includes a knife edge, which is also referred to as a cutting or lacerating edge. The knife edge may be sufficiently sharp, that is, as sharp as needed to lacerate or slice a thickness of the tread. A laceration or slice is also referred to as a discontinuity. When the sipe-forming element is arranged in the mold, the knife edge is oriented towards a first shoulder-molding portion of the pair of opposing shoulder-molding portions. This is desired so that the knife edge can cut through a thickness of the tread as the sipe-forming element is pulled in a lateral direction of the tire tread and toward a shoulder. To form a desired depth of the sipe, the knife edge has a length. The length generally extends in a direction transverse to a direction extending between the pair of opposing shoulder-molding portions, which means the length extends in a direction having a vector extending in the direction transverse to a direction extending between the pair of opposing shoulder-molding portions. This means the length of the knife edge may be entirely transverse or may be inclined in the direction extending between the pair of opposing shoulder-molding portions. It is also appreciated that the knife edge may be arranged below, or spaced apart, from the outermost molding surface to form a sipe recessed below the ground-engaging side within the thickness of the cured molded tread. It is also appreciated that the knife edge may be arranged to be arranged adjacent to, or to extend into a cavity within, the outermost molding surface so to form a sipe extending up to and along the ground-engaging side of the cured molded tread. Finally, it is also appreciated that the knife edge may form any sipe extending at any depth within the thickness of the cured molded tread, and at any depth relative to any other void formed within the thickness of the cured molded tread. It is also noted that the knife edge may be jagged or saw-tooth, for example, to improve its ability to cut or lacerate the tread.

In particular embodiments, the length of the knife edge extends along a linear path. In other embodiments, to increase the rigidity of the tread element or the tread, the length of the knife edge extends along a non-linear path. By extending along a non-linear path, the sipe-forming element is able to form a sipe having a depth or height extending along a non-linear path in a direction of the tread thickness. By providing a non-linear extension of the sipe depth or height, the local stiffness or rigidity of the tread is increased in a direction transverse to a direction of the sipe height or depth or to a direction of the tread thickness. This may further reclaim the loss in rigidity that naturally occurs when forming a sipe within the tread. It is noted that the non-linear path can be an undulating path having a plurality of peaks and valleys (that is, apexes and troughs), such as a sinusoidal path, a saw-tooth path, or a square-wave path, for example. Therefore, it is contemplated that the non-linear path may be curvilinear or comprise a plurality of linear segments, or any combination thereof.

The sipe-forming element further includes a knife edge translation member from which the knife edge and/or sipe-forming portion (which includes a knife edge) extends. The knife edge translation member is configured or arranged in association with the mold to translate the knife edge from a location between the pair of tire tread shoulders and toward one of the pair of tire tread shoulders. It is during this translation that the knife edge forms a sipe within the tire tread thickness. After cutting a sipe of desired length, during demolding operations the knife edge will either exit the shoulder toward which it translates or be lifted from the tread in a direction of the tread thickness and from the ground-engaging side of the tread such that the sipe formed does extend to the lateral extent of the tread and exit though the shoulder. It is appreciated that the knife edge or the sipe-forming portion may be operably attached or connected to the knife edge translation member in accordance with any known manner. For example, this attachment or connection may be achieved by welding, use of adhesive or mechanical fasteners, by way of interference-fitting, or by integral or monolithic formation with the translation member, such as by molding or machining operations, for example. It is also appreciated that the knife edge or the sipe-forming portion may extend in any direction from the knife edge translation member to form a sipe through any depth of the tread, such as the full depth or any partial depth of the tread thickness. For example, the knife edge may extend fully in the direction of the tread thickness or partially in the direction of the tread thickness at an angle biased to the direction of the tread thickness.

The knife edge translating member of the sipe-forming element is arranged outside of the mold cavity, such that it either forms a portion of the mold cavity or of the outermost molding surface or is spaced apart from the mold cavity or the outermost molding surface. In such instances, the knife edge translating member itself does not form a void within a thickness the tread since it is not arranged within the mold cavity. The knife edge translating member is arranged along the mold to translate the knife edge in a lateral direction of the tire tread, that is, in other words in a direction of the tread width and towards one of the pair of tread shoulders. By translating in a lateral direction of the tread, it is appreciated that a lateral direction may be directed completely in the lateral direction of the tread defining the width of the tread (that is, in a direction defining the tread width), where the direction defining the tread width is normal to a direction of the tread length defining a length of the tread (that is, in a direction defining the tread length), such that no vector component extends in the direction of the tread length. In translating in a lateral direction of the tread, it is also appreciated that a lateral direction may extend partially in a direction defining the tread width biased to both the direction defining the tread width and the direction defining the tread length, such that a vector component of the sipe length extends in the direction defining the tread length where such vector component is equal to or less than a vector component extending in the direction defining the tread width.

In particular embodiments, the mold further includes a void-forming element extending inward from the outermost molding surface, or in other words, into the molding cavity from the outermost molding surface. It is appreciated that any mold may comprise one or more (that is, one or a plurality of) void-forming elements. In an example where the mold cavity is substantially annular, it can be said that the void-forming element extends radially inward from the outermost molding surface. The void-forming element may be configured to form any desired void having a length extending in a longitudinal direction of the tread (that is, in a direction of the tread length). By extending in a longitudinal direction of the tread, it is appreciated that the longitudinal direction may extend completely in a direction of the tread length defining the tread length (that is, in a direction defining the tread length) or may be biased to the longitudinal direction defining the tread length, which is orthogonal to a direction of the tread width defining a width of the tread (that is, in a direction defining the tread width), such that a vector component of the void length extends in the direction defining the tread width and is less than a vector component extending in the direction defining the tread length. In particular embodiments, a void-forming element is configured to form a groove (operating as a groove-forming element), and more particularly a longitudinal groove (operating as a longitudinal groove-forming element) or a traditional sipe having a thickness substantially greater than zero. It is to be appreciated that the void-forming element may also be configured to form any desired void having a length extending in a lateral direction of the tread (that is, in a direction of the tread width).

It is appreciated that a sipe-forming element may be operably arranged in association with the mold in any manner sufficient to maintain the sipe-forming element in an arrangement spaced-apart from a shoulder-forming portion of the mold. It is appreciated that in any such arrangement, the sipe-forming element may be arranged to form a sipe having a length extending partially or fully across a tread element, such as a rib or tread block. For example, when the mold includes a void-forming element, in particular embodiments, the sipe-forming element is spaced apart from the void-forming element, such as a longitudinal groove-forming element, for example, in a direction towards the first shoulder-molding portion, such that in the step of demolding, the sipe formed is spaced apart from the void formed by the void-forming element. In other embodiments, the sipe-forming portion is arranged within a cavity of the void-forming element, such as the longitudinal groove-forming element, such that in the step of demolding, the sipe formed extends to the shoulder from the void formed by the void-forming element. It is appreciated that the cavity arranged within the void-forming element may extend partially or fully across a full width of the void-forming element. When extending fully across a full width of the void-forming element, in particular embodiments, the length of the knife edge may extend along a portion of the cross-sectional profile or outer perimeter of the void-forming element. Accordingly, in particular embodiments, the knife edge length extends to form, or is shaped to generally match, a portion of the cross-sectional profile of the void-forming element. In other words, the knife edge length extends in a direction substantially the same as a cross-sectional profile of the longitudinal groove. In even further embodiments, the sipe-forming portion has a shape substantially equal to the cross-sectional shape of the void-forming element. This occurs when the cavity extends through or substantially through the void-forming element. It is appreciated that the sipe-forming element may extend from a shoulder-molding portion and through a void-forming element to a more central region of the tire tread (longitudinal void-forming element), where the sipe-forming element forms a sipe within a tread elements arranged more central or inward from any tread elements arranged along the shoulder of the tread. For example, in certain instances, the sipe-forming element is configured such that the knife edge translates through a plurality of void-forming elements (two or more) and a cavity arranged in each of the plurality of void-forming elements. By further example, the knife edge may be arranged in one cavity of a void-forming element and after departing the one cavity, the knife edge passes through a second cavity arranged in a second void-forming element. In such embodiments, the sipe-forming portion is arranged on the second shoulder side of the groove-forming element, such that the sipe formed extends on a side of the groove nearest the second shoulder.

Additional embodiments of the method include a step of arranging an uncured tire tread within the mold. The uncured tire tread has a thickness extending depthwise from the outermost molding surface such that a portion of the tire tread is arranged between the knife edge and the first shoulder-molding portion. That is, a gap exists between the sipe-forming portion (and particularly the knife edge) and the first shoulder-molding portion to enable tread material to flow there between. After arranging the uncured tire tread within the mold, embodiments of the method include a step of molding the tire tread to form a cured molded tread having a thickness extending from a ground-engaging side of the tread. The ground-engaging side is also referred to as a top side, an outer side, or an exterior side of the tread. The ground-engaging side also includes at least one ground-engaging surface. Accordingly, when referencing a ground-engaging side of the tread, such as when describing the tread thickness or the location of a sipe or void, a ground-engaging surface may be substituted for the ground-engaging side for reference purposes. The cured molded tread also includes a pair of opposing shoulders extending along the lateral sides of the tread width in a direction of the tread thickness. As mentioned elsewhere herein, the tire tread may be molded alone (that is, separately from the tire) or while attached to a tire. During the molding process, the tread is cured, as the tread is generally formed of a curable elastomeric material, such as natural or synthetic rubber or any other polymeric material.

As a result of the step of molding, the tire tread includes a tread pattern, which is a predetermined arrangement of voids to provide a particular volumetric void ratio, surface void ratio, and layout of void and contact surfaces along a width and length of the tread. Volumetric void ratio is the ratio of volumetric void available at a particular worn depth of the tread relative to the total volume of the tread at the particular worn depth—where the total volume includes both void and tread material available. Surface void ratio is the ratio of surface void arranged along the outer side, or ground-engaging side, of the tread at a particular worn depth of the tread relative to the total surface area available of the tread at the particular worn depth—where the total area includes both void and tread areas arranged along the outer side.

As used in this application, the term “discontinuity” comprises any void, such as a groove or traditional sipe having a thickness or width substantially greater than zero, or any laceration, such as a zero-thickness sipe discussed herein, where any such discontinuity has a depth extending into the tread thickness. A void may be arranged along the ground-engaging side of the tread, or offset below the ground-engaging side of the tread to form a submerged void within the tread thickness. It is appreciated that a discontinuity may have a length extending in any direction transverse to the tread thickness, such as in a direction of the tread length and/or width. For example, the sipe or groove may be a longitudinal or lateral sipe or groove. Longitudinal grooves or sipe generally extend in a direction of the tread length, which may extend circumferentially around the tire. It is also contemplated that a longitudinal groove or sipe may extend at an angle biased to a circumferential direction of the tire. Lateral grooves or sipes generally extend in a direction of the tread width, where the lateral groove or sipe generally extends in a direction perpendicular to a longitudinal centerline of the tread (which extends in a direction of the tread length) or at an angle biased to the longitudinal centerline. It is appreciated that the length of any discontinuity may extend along any linear or non-linear path as desired, where a non-linear path is more fully described herein. Moreover, unless otherwise specified herein, any groove discussed herein may comprise a lateral or longitudinal groove and any sipe, whether or not a zero-thickness sipe, may comprise a lateral or longitudinal sipe. Accordingly, unless otherwise specified, a groove-forming element may be a longitudinal or lateral groove-forming element, which is configured to form a longitudinal or lateral groove, respectively. Likewise, unless otherwise specified, a sipe-forming element may be a longitudinal or lateral sipe-forming element, which is configured to form a longitudinal or lateral sipe, respectively.

With particular regard to the zero-thickness sipe, such sipe is a discontinuity comprising a laceration or slice extending through a thickness of the tread to define a depth or height of the sipe, the sipe having a length extending in a direction transverse to a thickness of the tread and a width or thickness extending transverse to both the length and depth of the sipe. Because the sipe is a laceration, the width or thickness of the sipe is substantially zero, as no material is being removed to form the sipe in the tread. Moreover, the sipe is formed such that the sipe is in a substantially zero-thickness arrangement when the tread is arranged annularly around the tire, where the sipe is in closed arrangement and appears as an slit or slice along the ground-engaging surface of the tread. In other words, when the tire tread is generally in an undeformed arrangement, the sipe is in a closed arrangement, where cut surfaces of the tread thickness on opposing sides of the sipe are in contact or in an abutting arrangement to define the substantially zero thickness of the sipe. In particular embodiments, it is understood that “substantially equal to zero” ranges from zero (0) to 0.2 mm, or 0 to 0.1 mm in other embodiments. Further, it is to be appreciated that, while the sipe described above may have a zero width or thickness at a moment of formation such that it appears closed, thermal expansion and/or contraction effects can result in a slight opening such that the opposing sides are no longer in full contact. Nonetheless, such a sipe is a zero-thickness sipe since, at the moment of formation, the opposing sides will be in contact since no material is removed.

In addition, such a sipe is a zero-thickness sipe even though the sipe may also open as the tire rolls through a contact patch during tire operation, where in the open arrangement the cut surfaces on opposing sides of the sipe are at least partially separated such that the sipe opens to a thickness greater than zero. The tire contact patch is the portion of the tread contacting a ground surface at any time during tire operation. In general, the sipe is closed in the contact patch. In instances where the tire operates under driving or braking torque, the sipe may open when located in a leading or trailing edge of the contact patch. In addition, as the sipe may open as it rolls through areas just before and/or just after the contact patch.

In contrast to a sipe as described above, a groove generally has perceptible width or opposing sides which are not in contact. It is also noted that an arrangement of grooves generally define a tread element, such as a rib or a lug. A rib is defined as a portion of ground-engaging surface arranged between spaced-apart longitudinal grooves or a longitudinal groove and one of opposing sides of the tread defining the width of the tread, extending substantially the full length of the tread. That is, the rib extends substantially continuously around the circumference of the tire. If a rib is discontinuous, for example, due to the presence of one or more lateral grooves extending fully across a rib, the separated portions of the rib are referred to as lugs or blocks. More generally, a portion of the ground-engaging surface defined by a pair of spaced-apart longitudinal grooves, or a longitudinal groove and one of the lateral sides of the tread width, and a pair of spaced-apart lateral grooves is known as a tread lug or block. The rib can be a shoulder rib located at a lateral side of the tread width (which may be adjacent to the sidewall when installed on a tire) or a center rib located between a pair of spaced-apart longitudinal grooves.

In further embodiments, the method includes a step of demolding the tire tread from the mold. In doing so, the knife edge of the sipe-forming element lacerates a thickness of the cured molded tread as the sipe-forming element is pulled in a direction toward the first shoulder-molding portion, or the shoulder that is has formed, the sipe having a length extending in a direction of the tread width from the shoulder formed by the first shoulder-molding portion. Pulling of the sipe-forming element is performed by pulling the sipe-forming element, such as by the knife edge translation member, relative to the molded tread and the mold (along which the sipe-forming element is arranged). This pulling is conducted after the tread is molded, yet before or while separating the surrounding mold from the tire tread. It is appreciated that pulling the sipe-forming element as described may be pulled according to any known or desired manner, whether manually or by use of one or more mechanisms. For example, one or more actuators may be employed to retract any sipe-forming elements from the mold.

The sipe formed in the step of demolding comprises a laceration having a thickness substantially equal to zero. As noted above, in particular embodiments, it is understood that “substantially equal to zero” ranges from zero (0) to 0.2 mm, or 0 to 0.1 mm in other embodiments. The resultant sipe has a length extending in a direction of the tread width. Further, it is noted that since tread material is not removed by the action of lacerating the tread thickness by the knife edge, the sipe has a substantially zero thickness or width extending transverse to the sipe length and by a depth into the cured molded tread thickness from the ground-engaging side of the cured molded tread.

It is appreciated that the length of the sipe may extend fully across a tread element, or partially across a tread element, such as when the sipe extends from a groove or other void on a first side of the tread element and terminates within the length or width of a tread element inward a second, opposing side of the tread element. Such a tread element may be a shoulder rib or shoulder tread block. It is also appreciated that in partially extending across a tread element, the sipe may be fully arranged inward of both first and second opposing sides of the tread element length or width. Accordingly, the length of the sipe can extend across substantially any portion of the tread element without intersecting any grooves, intersecting only one groove, or intersecting two grooves.

It is also appreciated that the sipe formed extends in a depthwise direction to extend partially or fully through the tread thickness. In particular embodiments, where the knife edge has a free terminal end opposite the knife edge translating member, the sipe formed has a free terminal end, meaning no void is arranged at the terminal end of the sipe. It is appreciated, however, that the terminal end of the knife edge may engage or operate within a groove arranged in, a void-forming member of the mold.

The void-forming member may form any desired void, such as a submerged lateral or longitudinal groove, for example. Also, because the knife edge can extend lengthwise along any path to form a sipe of a particular depth, it is appreciated that the sipe may extend depthwise along any linear or non-linear path. As discussed elsewhere herein, a non-linear path comprises an undulating path in particular embodiments.

Particular embodiments of the tires and methods discussed above will now be described in further detail below in association with the figures filed herewith exemplifying the performance of the methods in association with particular embodiments of the tires.

With reference to FIG. 1, a molded tire 10 according to an exemplary embodiment of the present invention is shown. The tire 10 includes a pair of sidewalls 12 each extending radially outward from a rotational axis of the tire to a central portion 14 of the tire 10. The central portion 14 of the tire extends annularly and includes a tread 20 having a thickness T₂₀ extending in a radial direction from a ground-engaging side 22 of the tread to a bottom side 24 for attachment and bonding to the tire. The tread also has a width W₂₀ extending in a lateral direction between the pair of opposing, lateral sides or side edges 21 of the tread arranged adjacent sidewalls 12. The tread also includes a pair of shoulders 21_{S} arranged along each side 21 extending along the tread thickness T₂₀.

With regard to the ground-engaging side 22 of the tread 20, it is shown to include a plurality of voids 26 comprising longitudinal grooves having a length extending in a direction of the tread length, which is in a circumferential direction of the tire. Each void 26 comprising a longitudinal groove also has a depth d₂₆ extending into the tread thickness T₂₀ from the ground-engaging side 22. The longitudinal grooves 26 define a plurality of tread elements comprising ribs also extending in a direction of the tread length. The plurality of ribs include both shoulder ribs 28_{S} bounded by a lateral side 21 of the tread width W₂₀ and a longitudinal groove 26 and center ribs 28_{C} bounded on both sides by a pair of spaced apart longitudinal grooves 26. Center ribs 28_{C} are arranged intermediately between shoulder ribs 28_{S}. While FIG. 1 illustrates a 4-rib tire, it is to be appreciated that the methods described herein can be utilized with tires having more or less ribs than tire 10.

According to the exemplary embodiment shown in FIG. 1, the tread 20 includes a plurality of sipes 30 comprising a laceration formed during a demolding operation, the sipe. In particular embodiments, the sipe has a thickness substantially equal to zero. Each sipe 30 extends into the tread thickness from the ground-engaging side 22 by a depth d₃₀, which in particular embodiments is equivalent to the length of the knife edge L₄₈ shown in FIGS. 2 and 3. It is appreciated that the depth d₃₀ of each sipe 30 may extend into the thickness of the tread 20 by a depth equal to, less than, or greater than the depth of any groove 26. Each sipe 30 also has a length extending transversely to the tread thickness and the sipe depth, which is represented as length L₃₀ in FIG. 1. With continued reference to the embodiment of FIG. 1, certain sipes 30 are shown to have a length extending fully across a tread element (which comprises a rib in the embodiment shown) from a first groove 26 to a second groove 26 or to a lateral side 21 or shoulder 21_{S} of the tread width W₂₀, while other sipes 30 are shown to have a length extending partial across a tread element from a first groove 26 and spaced apart from a second groove 26. Though shown in FIG. 1 as being aligned or co-linear, it is to be appreciated that sipes 30 can be otherwise arranged.

In the embodiment shown in FIG. 1, the sipes 30 arranged along the center ribs 28_{C} have lengths extending along linear paths. Further, the depth of each sipe 30 is shown to extend along a non-linear path, each of which are more specifically an undulating path. It is appreciated, however, that in other embodiments, the depth of any such void may extend along a linear path.

In particular embodiments, such as in the embodiment shown in FIG. 1, each sipe 30 extends toward the ground-engaging side 22 and terminating within the tread thickness and above or offset from the tread bottom side 24. In other words, each sipe 30 extends into the thickness of the tread 20 from the ground-engaging side and terminates above the bottom side 24. It is appreciated that by forming a zero-thickness sipe, the stiffness of the tread element and therefore the tread increases relative to using traditional sipe having a thickness substantially greater than zero. It is also appreciated that having a depth of the sipe-forming element extend along a non-linear path, the rigidity of the tread element and therefore the tread increases.

As discussed above in association with various methods, a zero-thickness sipe is formed by way of molding and demolding operations. In an exemplary embodiment in FIG. 2, a zero-thickness sipe 30 is formed in a tread 20 using a mold 40. Specifically, in FIG. 2, a portion of a tread 20 as a portion of tire 10 formed in mold 40, which includes an outermost molding side or surface 42 from which void-forming elements 44 extend into a molding cavity. The void-forming elements 44 are configured to form longitudinal grooves, such as the grooves 26 of FIG. 1, although in other embodiments the void-forming elements are used to form any other void, such as a traditional sipe having a thickness substantially greater than zero, lateral grooves, etc. The void-forming elements 44 are also shown to extend into the molding cavity by a distance less than the tread thickness T₂₀, but may extend fully through the tread thickness in other embodiments.

In the embodiment shown, the mold further includes a sipe-forming element 46 configured to form a zero-thickness sipe in tread 20, such as sipe 30 of FIG. 1. The sipe-forming element 46 includes a sipe-forming portion 50 with a knife edge 48 for lacerating a thickness of the tread as the sipe-forming element is removed from the tread by pulling the element outwardly from the tread thickness and towards a shoulder of the tread. To achieve its intended purpose, the knife edge 48 is spaced a distance from the shoulder-forming portion 43 of the mold, which is arranged adjacent to tread shoulder 21_{S} or side edge 21 of the tread in FIG. 2. By doing so, an area or gap is formed between the shoulder-forming portion 43 and the knife edge 48 for receiving tread material. During the molding operation, tread material is arranged in the area between the shoulder-forming portion 43 and the knife edge 48. Once the tire tread 20 is cured, the tire 10 is demolded from mold 40. During removal, the sipe-forming element 46 is drawn outwardly through the tread thickness between the shoulder-forming portion 43 and the knife edge 48 to form a sipe comprising a laceration as exemplarily shown in FIG. 1. It is appreciated that, in particular embodiments where the tread is molded separately from the tire, such as when forming an annular tread for retreading operations, the sipe-forming element may be arranged below the tread thickness, so that the knife edge is pulled through the entire thickness of the tread to form a full-depth zero-thickness sipe.

As discussed above, the sipe-forming element further includes a knife edge translation member. In the exemplary embodiments of FIGS. 2 and 3, sipe-forming element 46 includes a knife edge translation member 52, from which the knife edge 48 and sipe-forming portion 50 extends. The knife edge translation member 52 is configured or arranged in association with the mold 40 to translate the knife edge from a location between a pair of tire tread shoulders and toward the tire tread shoulder 21_{S} shown. It is during this translation that the knife edge forms a sipe within the tire tread thickness. In forming the sipes 30 within the tread of FIG. 1, according to a particular embodiment, after cutting a sipe of desired length, during demolding operations the knife edge exits the shoulder toward which it translates. With reference to the embodiment shown in FIG. 2, the knife edge translating member 52 of the sipe-forming element 46 is arranged outside of the mold cavity, such that it forms a portion of the mold cavity or of the outermost molding surface. In such instances, the knife edge translating member itself does not form a void within a thickness the tread since it is not arranged within the mold cavity.

In FIG. 3, the sipe-forming element 46 of FIG. 2 is shown in further detail. In particular, the sipe-forming element 46 has a knife edge having a length L₄₈ extending along a non-linear path, which in particular forms an undulating path. While it is appreciated that the knife edge may extend along any desired non-linear path, the path may also be linear. For example, an exemplary sipe-forming element 46 is shown in FIG. 5 where the knife edge 48 extends along a linear path.

As discussed above, it is appreciated that a sipe-forming element may be operably arranged in association with the mold in any manner sufficient to maintain the sipe-forming element in an arrangement spaced-apart from a shoulder-forming portion of the mold to form a sipe having a length extending partially or fully across a tread element, such as a rib or tread block. While in particular embodiments the sipe-forming element is spaced apart from a void-forming element, such as a longitudinal groove-forming element, for example, in a direction towards the first shoulder-molding portion, in other embodiments, such as exemplarily shown in FIGS. 2 and 4, the sipe-forming portion 50 is arranged within a cavity 45 of the void-forming element 44, such that in the step of demolding, the sipe formed extends to the shoulder from the void formed by the void-forming element. In the embodiment shown, the cavity 45 arranged within the void-forming element 44 extends partially across a partial width of the void-forming element, although as discussed above it is appreciated that the cavity may extend across the full width of the void-forming element. As best shown in FIG. 2, the knife edge 48 is shaped to match a portion of the cross-sectional outer profile (or outer perimeter) 44_{P} of the void-forming element. In the embodiment shown, the sipe-forming portion 50 is configured to extend through a second void-forming element 44 and a cavity 45 arranged therein to form a sipe within multiple tread elements as the sipe-forming element is translated in a direction of the shoulder-forming portion 21_{S}. In other variations, it is appreciated that the sipe-forming element 46 may extend from an opposing shoulder-forming portion 43 and through the void-forming element 44 to a more central region of the tire tread, where the sipe-forming element forms a sipe within a tread elements (such as tread elements 28_{C} in FIG. 1) arranged more central or inward from any tread elements arranged along the shoulder of the tread (such as shoulder tread elements 28_{S} in FIG. 1).

In accordance with certain finite element analysis (FEA) simulations conducted, benefits of zero-thickness sipes, as generally described herein, are exemplified in the chart shown in FIG. 6. In FIG. 6, the chart shown generally illustrates a percentage increase in rigidity for zero-thickness sipes over standard sipes, for different thicknesses of a sipe extending into a ground-engaging side of the tread. This increase in rigidity (also referred to as “transverse rigidity”) occurs in a direction transverse to the direction of the tread thickness and transverse to a direction of the sipe length. Specifically, for these evaluations, zig-zag (undulating) zero-thickness sipes were evaluated.

Upon review of the results shown in the chart of FIG. 6, a comparison of transverse rigidity obtained from FEA simulations conducted between tread blocks having zig-zag (undulating)sipes of various thicknesses relative a standard zig-zag sipe of 0.6 mm For each of the zero-thickness sipes (0.2 mm or less) and the standard sipes (0.4 mm or greater), the zig-zag sipes extended into the tread thickness along a zig-zag or undulating path. For these simulations, the tire tread thickness is 8.5 mm and the total depth of each sipe is 8 mm. The simulations were performed using FEA on a 2-dimensional tread model, where the bottom side of the tread was fixed (that is, constrained in all directions) while a lateral shearing load was applied to the ground-engaging side by way of imposing a lateral displacement on the tread. A normal load was also applied concurrently with application of the lateral shearing load. Upon review of the results, which are reflected in FIG. 6, an increase in transverse rigidity is realized in all tread blocks having zero-thickness sipes as compared to tread blocks having standard sipes. In particular, an increase of at least approximately 10% in transverse rigidity is obtained when employing zero-thickness sipes over standard sipes.

Based upon these results, in view of the broader invention, because the substantially zero-thickness sipes may extend lengthwise in any direction of the tire or tire tread, it can be said that increases in rigidity are realized in a direction transverse to the length of the sipe. Therefore, when employing substantially zero-thickness sipes as described herein, an increase in rigidity (also referred to as “transverse rigidity”) is obtained in any direction of the tire or tire tread transverse to both the tread thickness and the length of the sipe, which may comprise a longitudinal or lateral direction of the tire or tire tread, or any direction there between. Therefore, the increase in rigidity may be an increase in longitudinal or lateral rigidity, for example. It is noted that the simulations evaluate the benefit of employing substantially zero-thickness sipes without considering any benefits associated with the length of the sipe extending along a non-linear path.

It is appreciated that formation of zero-thickness sipes on the outer side of the tread may be performed by any manual or automated process or machine, of which may contain a processor and memory storage device configured to store instructions for performing the method steps discussed and contemplated herein.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The terms “at least one” and “one or more” are used interchangeably. The term “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (i.e., not required) feature of the invention. Ranges that are described as being “between a and b” are inclusive of the values for “a” and “b” unless otherwise specified.

While this invention has been described with reference to particular embodiments thereof, it shall be understood that such description is by way of illustration only and should not be construed as limiting the scope of the claimed invention. Accordingly, the scope and content of the invention are to be defined only by the terms of the following claims. Furthermore, it is understood that the features of any specific embodiment discussed herein may be combined with one or more features of any one or more embodiments otherwise discussed or contemplated herein unless otherwise stated.

1. A method of forming a tire, the method comprising:
providing a mold configured to mold a tire tread, the mold having a molding cavity defined at least in part by an outermost molding surface configured to form a ground-engaging surface of the tire tread and a pair of opposing shoulder-forming portions configured to form a pair of opposing shoulders of the tire tread, the outermost molding surface being arranged between the pair of opposing shoulder-forming portions, the mold further including a sipe-forming element spaced apart inwardly from each of the pair of opposing shoulder-forming portions, the sipe-forming element including a knife edge oriented towards a first shoulder-forming portion of the pair of opposing shoulder-forming portions and the knife edge having a length extending in a direction transverse to a direction extending between the pair of opposing shoulder-forming portions, the sipe-forming element further including a knife edge translation member arranged outside the mold cavity and configured to translate in a direction towards the first shoulder-forming portion and from which a sipe-forming portion extends, the sipe-forming portion including the knife edge;
arranging an uncured tire tread within the mold, the uncured tire tread having a thickness extending depthwise from the outermost molding surface such that a portion of the tire tread is arranged between the knife edge and the first shoulder-forming portion;
molding the tire tread arranged within the mold to form a cured molded tread having a thickness extending from a ground-engaging side of the cured molded tread and a width extending between opposing lateral sides of the tire tread, the tire tread further including a pair of shoulders each arranged along one of the lateral sides of the tire tread, each of the shoulders extending in a direction of the tread thickness; and
demolding the tire tread from the mold such that the sipe-forming element forms a sipe by the knife edge lacerating a thickness of the cured molded tread as the sipe-forming element is pulled in a direction toward the first shoulder-forming portion, the sipe comprising a laceration having a thickness substantially equal to zero and having length extending in a direction of the tread width from the first shoulder formed by the first shoulder-forming portion.

2. The method of claim 1, where the mold further includes a groove-forming element extending inward from the outermost molding surface, such that in the step of molding, the groove-forming element forms a groove in the cured molded tread, the groove extending into the thickness of the cured molded tread from the ground-engaging side.

3. The method of claim 2, where the sipe-forming portion is arranged within a cavity of the groove-forming element, such that in the step of demolding, the sipe formed extends to the first shoulder from the groove formed by the groove-forming element.

4. The method of claim 3, where the knife edge length extends in a direction substantially the same as a cross-sectional profile of the groove.

5. The method of claim 1, where the sipe-forming portion has a shape substantially equal to a cross-sectional shape of the groove-forming element.

6. The method of claim 2, where the sipe-forming element is spaced apart from the groove-forming element in a direction towards the first shoulder-forming portion, such that in the step of demolding, the sipe formed is spaced apart from the groove formed by the groove-forming element.

7. The method of claim 1, where the length of the knife edge extends along a non-linear path such that a depth of the sipe extends along the same non-linear path.

8. The method of claim 7, where the non-linear path is an undulating path.

9. The method of claim 2, where the sipe-forming portion is configured to translate through a cavity arranged within the groove-forming portion.

10. The method of claim 9, where the sipe formed extends from the ground-engaging side of the tire tread to a depth above the bottom side of the tread.

11. The method of claim 1, where the tire tread is bonded to a tire in the step of molding.

12. A molded tire, comprising:
a pair of sidewalls extending radially outward to a central portion of the tire, the pair of sidewalls being spaced apart in an axial direction of the tire;
a tire tread having a width extending in a lateral direction between a pair of opposing lateral sides of the tire tread and a pair of shoulders spaced apart and on opposing lateral sides of the tread width, the tire tread being arranged along a radially outer side of the central portion between the pair of sidewalls, the tire tread having a thickness extending from a ground-engaging side to a bottom side within the central portion of the tire; and,
a sipe comprising a laceration formed during a demolding operation, the sipe having a length extending in a direction of the tread width from a first shoulder of the pair of shoulders of the tire tread and a depth extending in a direction of the tread thickness to a free terminal end within the tread thickness.

13. The tire of claim 12, where the sipe has a thickness substantially equal to zero.

14. The tire of claim 12, where the sipe has a thickness equal to or less than 0.2 mm.

15. The tire of claim 12, where the tire tread further includes a longitudinal void extending into the thickness of the tire tread from the ground-engaging side and where the sipe extends from the longitudinal void in a direction of the tread width and to the first shoulder.

16. The tire of claim 12, where the tire tread further includes a longitudinal void extending into the thickness of the tire tread from the ground-engaging side and where the sipe is spaced apart from the longitudinal void in the direction of the first shoulder.

17. The tire of claim 12, where the depth of the sipe extends along a non-linear path.

18. The tire of claim 17, where the non-linear path is an undulating path.

19. The tire of claim 12, where the sipe extends from the ground-engaging side of the tire tread to a depth of the tread thickness above the bottom side of the tread.

20. A molded tire formed by the method recited in claim 12.
